(19) United States
(12) Patent Application Publication
(10) Pub. No.: US 2026/0310907 A1
(43) Pub. Date: Oct. 8, 2026

(54) INFORMATION PROCESSING SYSTEM AND INFORMATION PROCESSING METHOD

(71) Applicant: SEMICONDUCTOR ENERGY LABORATORY CO., LTD., Atsugi-shi (JP)

(72) Inventors: Junpei MOMO, Sagamihara (JP); Natsuko TAKASE, Isehara (JP)

(21) Appl. No.: 19/577,645

(22) Filed: Mar. 25, 2026

(30) Foreign Application Priority Data
Apr. 3, 2025 (JP) 2025-062072

(51) Int. Cl. G06F 40/40; G06F 16/248; G06F 40/169

(52) U.S. Cl. CPC G06F 40/40; G06F 16/248; G06F 40/169

(57) ABSTRACT

A novel information processing system that is highly convenient, useful, or reliable is provided. The information processing system includes a first component, a second component, and a third component. The first component has a function of receiving a document and transmitting it to the third component and a function of receiving and providing a comment. The second component has a function of generating a question, an answer, and the comment with the use of a large language model. The third component has a function of receiving the document, the question, the answer, and the comment and internally sharing them, and a function of transmitting a prompt to the second component. The third component also has a function of creating the prompt. Thus, the question, the answer, and the comment regarding the document can be generated.

### BACKGROUND OF THE INVENTION

### 1. Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include an information processing device, a semiconductor device, a memory device, a method for driving any of these devices, and a method for manufacturing any of these devices.

### 2. Description of the Related Art

In recent years, language models using neural networks have been actively developed, and especially large language models (LLMs) have attracted attention. A large language model is a natural language processing model trained using a large amount of data. With a large language model, for example, an interactive model that gives an answer to a user's instruction can be achieved. In Non-Patent Document 1, Generative Pre-trained Transformer 4 (GPT-4, registered trademark) is disclosed as a large language model, and ChatGPT is disclosed as an interactive model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing an external service that provides a language model is one of the utility forms of a language model.

Patent Document 1 discloses an information processing device that receives document data, divides text included in the document data into a plurality of sentences, and extracts a sentence classified in a first category of sentences which describe a structure but do not describe an effect and a sentence classified in a second category of sentences which describe an effect but do not describe a structure from the plurality of sentences.

### REFERENCES

### Non-Patent Document

Non-Patent Document 1. Summary of ChatGPT/GPT-4 Research and Perspective Towards the Future of Large Language Models, Yiheng Liu et al., (submitted on 4 April, 2023) [online], Internet URL: https://arxiv.org/abs/2304.01852

### PATENT DOCUMENT

Patent Document 1. PCT International Publication No. WO2024/176060

### SUMMARY OF THE INVENTION

One object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

Note that the description of these objects does not preclude the existence of other objects. One embodiment of the present invention does not need to achieve all of these objects. Other objects will be apparent from and can be derived from the description of the specification, the drawings, the claims, and the like.
(1) One embodiment of the present invention is an information processing system having a function of receiving a document and providing a comment on description of the document relevant to a question. A first answer to the question includes an impossibility to answer, and the question is relevant to the document or the first answer not including the impossibility to answer.
(2) One embodiment of the present invention is an information processing system having a function of receiving a document and providing a comment, a function of transmitting a first prompt to a large language model and receiving a question, a function of transmitting a second prompt to the large language model and receiving an answer, and a function of transmitting a third prompt to the large language model and receiving the comment.
The first prompt includes a first instruction, an object, and a conversation history, and the first instruction includes a procedure for generating the question about the object in consideration of the conversation history. Note that the object is the document or the answer. The conversation history includes the question and the answer.
The second prompt includes a second instruction, the question, and the document, and the second instruction includes a procedure for generating the answer to the question from description of the document. Note that the answer can include an impossibility to answer.
The third prompt includes a third instruction, the question, the answer, and the document, and the third instruction includes a procedure for generating the comment on the description of the document relevant to the answer to the question.
(3) One embodiment of the present invention is an information processing system including a first component, a second component, and a third component.
The first component has a function of receiving a document and transmitting the document to the third component and a function of receiving and providing a comment.
The second component has a function of receiving a first prompt and transmitting a question to the third component, a function of receiving a second prompt and transmitting a first answer to the third component, a function of receiving a third prompt and transmitting the comment to the third component, and a function of performing processing using a large language model. The large language model has a function of generating the question in accordance with the first prompt, a function of generating the first answer in accordance with the second prompt, and a function of generating the comment in accordance with the third prompt.
The third component has a function of receiving the document, the question, the first answer, and the comment and sharing the document, the question, the first answer, and the comment in the third component; a function of transmitting the first prompt, the second prompt, and the third prompt to the second component; and a function of transmitting the comment to the first component. The third component includes a first subcomponent.
The first subcomponent has a function of creating the first prompt, the second prompt, and the third prompt.
The first prompt includes a first instruction, an object, and a conversation history, and the first instruction includes a procedure for generating the question about the object in consideration of the conversation history. Note that the object is the document or the first answer, and the conversation history includes the question and the first answer.
The second prompt includes a second instruction, the question, and the document, and the second instruction includes a procedure for generating the first answer to the question from description of the document. Note that the first answer can include an impossibility to answer.
The third prompt includes a third instruction, the question, the first answer, and the document, and the third instruction includes a procedure for generating the comment on the description of the document relevant to the first answer to the question.
Accordingly, the question about the description of the document can be created. The first answer to the question about the description of the document can be created. The question and the first answer regarding the description of the document can be repeatedly created. The description of the document can be examined in detail. The comment on the description of the document relevant to the first answer to the question can be provided. Thus, a novel information processing system that is highly convenient, useful, or reliable can be provided.
(4) One embodiment of the present invention is the above-described information processing system in which the first subcomponent has a function of creating the first prompt when the document or the first answer not including the impossibility to answer is shared; a function of creating the second prompt when the question is shared; and a function of creating the third prompt when the first answer including the impossibility to answer is shared.
Accordingly, the question can be generated when the document or the first answer not including the impossibility to answer is shared. The comment can be generated when the first answer including the impossibility to answer is shared. The comment on the description of the document relevant to the first answer to the question can be provided. The comment can be used to promote the user of the information processing system to refine the document, for example. Thus, a novel information processing system that is highly convenient, useful, or reliable can be provided.
(5) One embodiment of the present invention is the above-described information processing system in which the first component has a function of receiving and providing a record.
The third component has a function of creating the record and transmitting the record to the first component. Note that the record includes the question and the first answer.
Accordingly, the record can be used to promote the user of the information processing system to refine the document, for example. Thus, a novel information processing system that is highly convenient, useful, or reliable can be provided.
(6) One embodiment of the present invention is the above-described information processing system in which the first component has a function of receiving a question material and transmitting the question material to the third component. The question material includes one or both of a concept notebook and a frequently asked question. The document is based on the concept notebook.
The third component has a function of receiving the question material and sharing the question material in the third component. The first prompt includes the first instruction, the object, the conversation history, and the question material. The first instruction includes a procedure for generating the question about the object in consideration of the conversation history with reference to the question material.
Accordingly, the question can be created with reference to the concept notebook. Whether the content of the concept notebook is described without omission in the document can be examined in detail. The question can be created with reference to the frequently asked question. Whether the document is written to allow generation of an answer to the frequently asked question can be examined in detail. Thus, a novel information processing system that is highly convenient, useful, or reliable can be provided.
(7) One embodiment of the present invention is the above-described information processing system in which the first component has a function of receiving and providing a supplement.
The second component has a function of receiving a fourth prompt and a fifth prompt and transmitting the supplement to the third component. The large language model has a function of generating a second answer to the question in accordance with the fourth prompt and a function of generating the supplement relevant to the second answer in accordance with the fifth prompt.
The third component has a function of receiving the supplement and transmitting the supplement to the first component, a function of transmitting the fourth prompt and the fifth prompt to the second component, and a function of sharing a search result set in the third component. The third component includes a second subcomponent.
The first subcomponent has a function of creating a query, the fourth prompt, and the fifth prompt. The query includes a request to collect a reference relevant to the question from a database and create the search result set. The reference is within a range of ordinary knowledge in a field of the document. The fourth prompt includes a fourth instruction, the question, and the search result set, and the fourth instruction includes a procedure for generating the second answer to the question from the reference. The second answer includes literature information specifying the reference, and the fifth prompt includes a fifth instruction, the second answer, and the document. The fifth instruction includes a procedure for generating the supplement to the description of the document from the second answer. Note that the second answer can include the impossibility to answer.
The second subcomponent has a function of performing processing using the database and a management system. The database has a function of storing the reference, and the management system has a function of creating the search result set from the database in response to the query.
Accordingly, for example, the reference can be collected in the range of the ordinary knowledge in the field of the document. The second answer to the question can be generated from the reference. The literature information can be used to provide the basis for the second answer to the question. The supplement can be used to provide the second answer to the question. Thus, a novel information processing system that is highly convenient, useful, or reliable can be provided.
(8) One embodiment of the present invention is the above-described information processing system in which the first subcomponent has a function of creating the query when the first answer including the impossibility to answer is shared; a function of creating the fourth prompt when the search result set is shared; a function of creating the fifth prompt when the second answer not including the impossibility to answer is shared; and a function of creating the third prompt when the second answer including the impossibility to answer is shared.
Accordingly, when the first answer including the impossibility to answer is shared, the query can be created and the search result set including the reference can be created from the database. When the search result set is shared, the second answer to the question can be generated from the reference. When the second answer does not include the impossibility to answer, the supplement to the description of the document relevant to the second answer to the question can be generated from the second answer. The supplement can be used to promote the user of the information processing system to refine the document, for example. When the second answer includes the impossibility to answer, the comment on the description of the document relevant to the question can be provided. The comment can be used to promote the user of the information processing system to refine the document, for example. Thus, a novel information processing system that is highly convenient, useful, or reliable can be provided.
(9) One embodiment of the present invention is an information processing method including a first step, a second step, a third step, a fourth step, a fifth step, a sixth step, a seventh step, an eighth step, a ninth step, a tenth step, an eleventh step, a twelfth step, and a thirteenth step.
In the first step, a first component receives a document and transmits the document to a second component.
In the second step, the second component receives the document and shares the document in the second component. Note that the second component includes a first subcomponent.
In the third step, the first subcomponent creates a first prompt and transmits the first prompt to a third component. Note that the first prompt includes a first instruction, an object, and a conversation history, and the first instruction includes a procedure for generating a question about the object in consideration of the conversation history. The object is the document when the first prompt is created for the first time, and is a first answer when the first prompt is created for the second and subsequent times. The conversation history includes the question and the first answer when the first prompt is created for the second and subsequent times.
In the fourth step, the third component receives the first prompt, generates the question with use of a large language model, and transmits the question to the second component.
In the fifth step, the second component receives the question and shares the question in the second component.
In the sixth step, the first subcomponent creates a second prompt and transmits the second prompt to the third component. Note that the second prompt includes a second instruction, the question, and the document, and the second instruction includes a procedure for generating the first answer to the question from description of the document. The first answer can include an impossibility to answer.
In the seventh step, the third component receives the second prompt, generates the first answer with use of the large language model, and transmits the first answer to the second component.
In the eighth step, the second component receives the first answer and shares the first answer in the second component.
In the ninth step, when the second component shares the first answer not including the impossibility to answer, a process proceeds to the third step, and when the second component shares the first answer including the impossibility to answer, the process proceeds to the tenth step.
In the tenth step, the first subcomponent creates a third prompt and transmits the third prompt to the third component. Note that the third prompt includes a third instruction, the question, and the document, and the third instruction includes a procedure for generating a comment on the description of the document relevant to the first answer to the question.
In the eleventh step, the third component receives the third prompt, generates the comment with use of the large language model, and transmits the comment to the second component.
In the twelfth step, the second component receives the comment and transmits the comment to the first component.
In the thirteenth step, the first component receives and provides the comment.
Accordingly, the question about the description of the document can be created. The first answer to the question about the description of the document can be created. The question and the first answer regarding the description of the document can be repeatedly created. The description of the document can be examined in detail. The comment on the description of the document relevant to the first answer to the question can be provided. The question can be generated when the document or the first answer not including the impossibility to answer is shared. The comment can be generated when the first answer including the impossibility to answer is shared. The comment on the description of the document relevant to the first answer to the question can be provided. The comment can be used to promote the user of the information processing system to refine the document, for example. Thus, a novel information processing method that is highly convenient, useful, or reliable can be provided.
(10) One embodiment of the present invention is the above-described information processing method including a fourteenth step, a fifteenth step, a sixteenth step, a seventeenth step, an eighteenth step, a nineteenth step, a twentieth step, a twenty-first step, a twenty-second step, a twenty-third step, and a twenty-fourth step instead of the ninth step.
In the fourteenth step, when the second component shares the first answer not including the impossibility to answer, the process proceeds to the third step, and when the second component shares the first answer including the impossibility to answer, the process proceeds to the fifteenth step.
In the fifteenth step, the first subcomponent creates a query and shares the query in the second component. Note that the query includes a request to collect a reference relevant to the question from a database and create a search result set. The reference is within a range of ordinary knowledge in a field of the document. The second component includes a second subcomponent, and the second subcomponent has a function of performing processing using the database and a management system. The database has a function of storing the reference, and the management system has a function of creating the search result set from the database in response to the query.
In the sixteenth step, the second subcomponent creates the search result set and shares the search result set in the second component.
In the seventeenth step, the first subcomponent creates a fourth prompt and transmits the fourth prompt to the third component. Note that the fourth prompt includes a fourth instruction, the question, and the search result set, and the fourth instruction includes a procedure for generating a second answer to the question from the reference. The second answer includes literature information specifying the reference, and the second answer can include the impossibility to answer.
In the eighteenth step, the third component receives the fourth prompt, generates the second answer with use of the large language model, and transmits the second answer to the second component.
In the nineteenth step, the second component receives the second answer and shares the second answer in the second component.
In the twentieth step, when the second component shares the second answer including the impossibility to answer, the process proceeds to the tenth step, and when the second component shares the second answer not including the impossibility to answer, the process proceeds to the twenty-first step.
In the twenty-first step, the first subcomponent creates a fifth prompt and transmits the fifth prompt to the third component. Note that the fifth prompt includes a fifth instruction, the second answer, and the document, and the fifth instruction includes a procedure for generating a supplement to the description of the document from the second answer.
In the twenty-second step, the third component receives the fifth prompt, generates the supplement with use of the large language model, and transmits the supplement to the second component.
In the twenty-third step, the second component receives the supplement and transmits the supplement to the first component.
In the twenty-fourth step, the first component receives and provides the supplement.

Accordingly, for example, the reference can be collected in the range of the ordinary knowledge in the field of the document. The second answer to the question can be generated from the reference. The literature information can be used to provide the basis for the second answer to the question. The supplement can be used to provide the second answer to the question. When the first answer including the impossibility to answer is shared, the query can be created and the search result set including the reference can be created from the database. When the search result set is shared, the second answer to the question can be generated from the reference. When the second answer does not include the impossibility to answer, the supplement to the description of the document relevant to the question can be generated from the second answer. The supplement can be used to promote the user of the information processing system to refine the document, for example. When the second answer includes the impossibility to answer, the comment on the description of the document relevant to the question can be provided. The comment can be used to promote the user of the information processing system to refine the document, for example. Thus, a novel information processing method that is highly convenient, useful, or reliable can be provided.

With one embodiment of the present invention, a novel information processing system that is highly convenient, useful, or reliable can be provided. A novel information processing method that is highly convenient, useful, or reliable can be provided. A novel information processing system, a novel information processing method, or a novel semiconductor device can be provided.

The description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

FIG. 1 illustrates a structure of an information processing system of an embodiment.

FIG. 2A illustrates a structure of a component used in an information processing system of an embodiment, and FIG. 2B illustrates a structure of a conversation history provided by the information processing system of the embodiment.

FIG. 3 illustrates a structure of a component used in an information processing system of an embodiment.

FIGS. 4A and 4B each illustrate a structure of a prompt used in an information processing system of an embodiment.

FIGS. 5A and 5B each illustrate a structure of a prompt used in an information processing system of an embodiment.

FIG. 6 illustrates a structure of an information processing system of an embodiment.

FIG. 7A illustrates a structure of a component used in an information processing system of an embodiment, and FIG. 7B illustrates a structure of a conversation history provided by the information processing system of the embodiment.

FIG. 8 illustrates a structure of a component used in an information processing system of an embodiment.

FIGS. 9A to 9C each illustrate a structure of a search result set or a prompt used in an information processing system of an embodiment.

FIG. 10 illustrates a structure of an information processing device used for an information processing system of an embodiment.

FIG. 11 illustrates an information processing method of an embodiment.

FIG. 12 illustrates an information processing method of an embodiment.

FIG. 13 illustrates an information processing method of an embodiment.

FIG. 14 illustrates an information processing method of an embodiment.

### DETAILED DESCRIPTION OF THE INVENTION

An information processing system of one embodiment of the present invention includes a first component, a second component, and a third component.

The first component has a function of receiving a document and transmitting the document to the third component and a function of receiving and providing a comment.

The second component has a function of receiving a first prompt and transmitting a question to the third component, a function of receiving a second prompt and transmitting a first answer to the third component, a function of receiving a third prompt and transmitting the comment to the third component, and a function of performing processing using a large language model. The large language model has a function of generating the question in accordance with the first prompt, a function of generating the first answer in accordance with the second prompt, and a function of generating the comment in accordance with the third prompt.

The third component has a function of receiving the document, the question, the first answer, and the comment and sharing the document, the question, the first answer, and the comment in the third component; a function of transmitting the first prompt, the second prompt, and the third prompt to the second component; and a function of transmitting the comment to the first component. The third component includes a first subcomponent.

The first subcomponent has a function of creating the first prompt, the second prompt, and the third prompt. The first prompt includes a first instruction and an object, the first instruction includes a procedure for generating the question about the object, and the object is the document or the first answer. The second prompt includes a second instruction, the question, and the document, and the second instruction includes a procedure for generating the first answer to the question from description of the document. Note that the first answer can include an impossibility to answer. The third prompt includes a third instruction, the question, the first answer, and the document, and the third instruction includes a procedure for generating the comment on the description of the document relevant to the first answer to the question.

Accordingly, the question about the description of the document can be created. The first answer to the question about the description of the document can be created. The question and the first answer regarding the description of the document can be repeatedly created. The description of the document can be examined in detail. The comment on the description of the document relevant to the first answer to the question can be provided. Thus, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as "first" and "second" in this specification and the like are used in order to avoid confusion among components and thus do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### EMBODIMENT 1

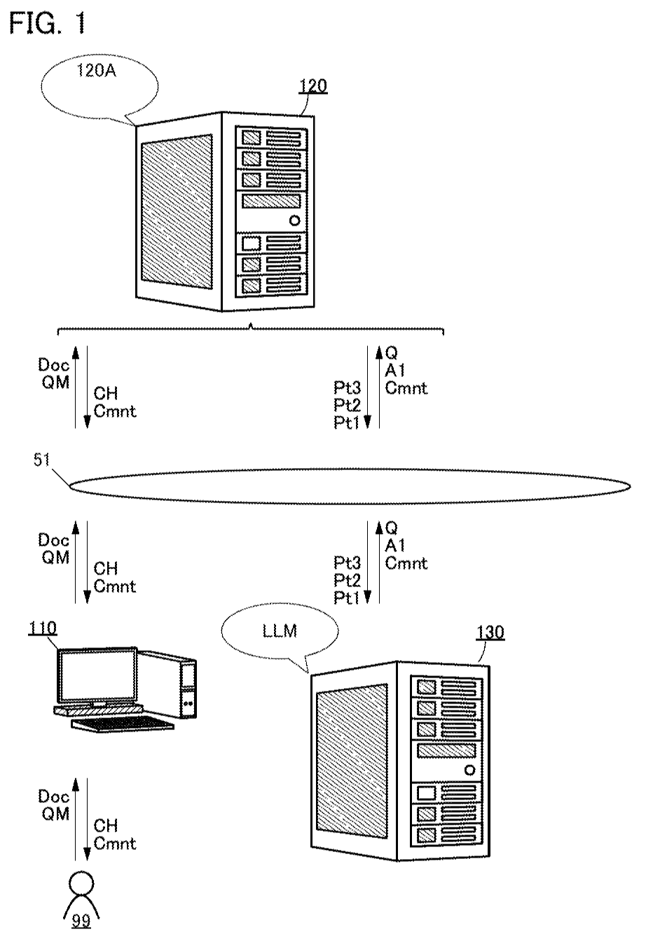

In this embodiment, an information processing system of one embodiment of the present invention will be described with reference to FIGS. 1, 2A and 2B, 3, 4A and 4B, 5A and 5B, 6, 7A and 7B, 8, 9A-9C, and 10.

FIG. 1 illustrates a structure of the information processing system of one embodiment of the present invention.

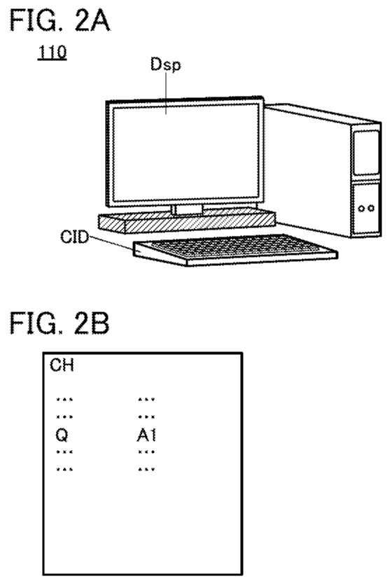

FIG. 2A illustrates a structure of a component that can be used in the information processing system of one embodiment of the present invention, and FIG. 2B illustrates a structure of a record provided by the information processing system of one embodiment of the present invention.

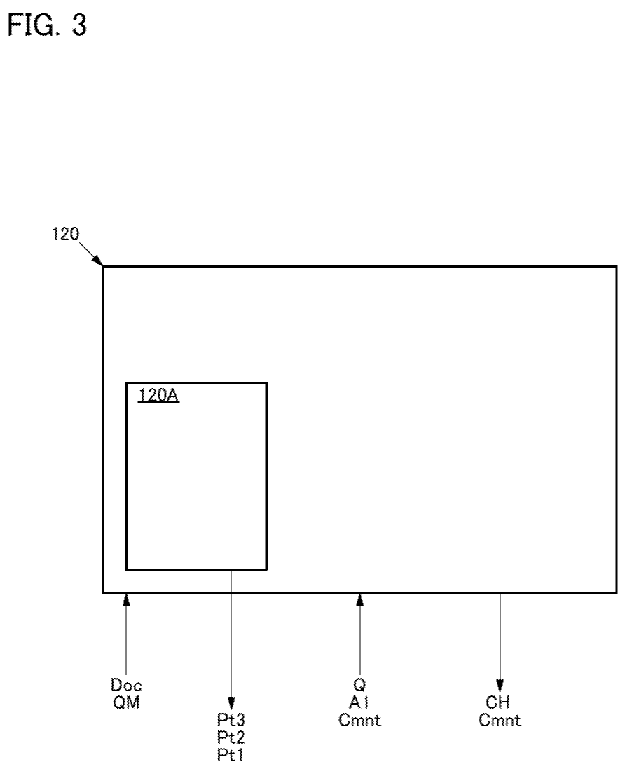

FIG. 3 illustrates a structure of a component that can be used in the information processing system of one embodiment of the present invention.

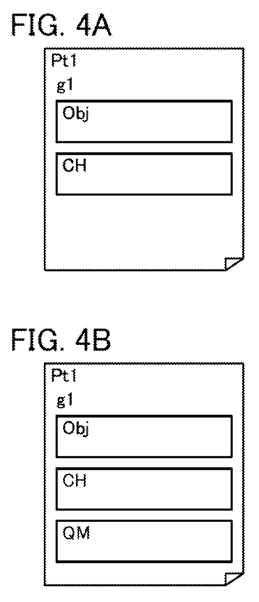

FIGS. 4A and 4B illustrate structures of a prompt transmitted and received inside the information processing system of one embodiment of the present invention.

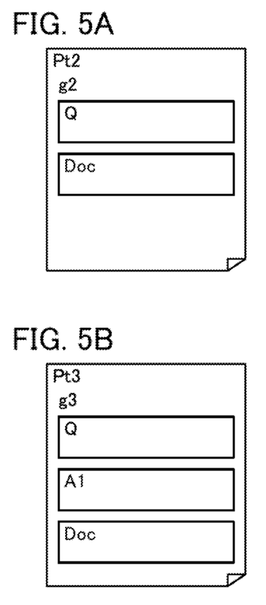

FIGS. 5A and 5B each illustrate a structure of a prompt transmitted and received inside the information processing system of one embodiment of the present invention.

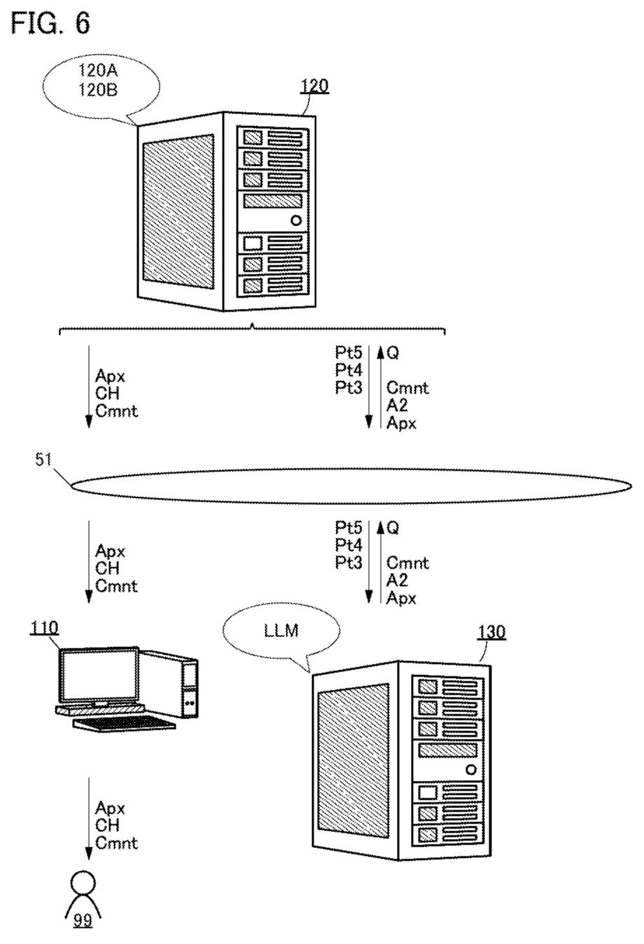

FIG. 6 illustrates a structure of the information processing system of one embodiment of the present invention.

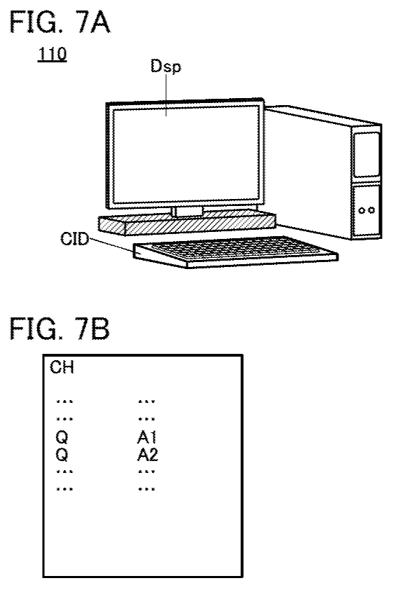

FIG. 7A illustrates a structure of the component that can be used in the information processing system of one embodiment of the present invention, and FIG. 7B illustrates a structure of the record provided by the information processing system of one embodiment of the present invention.

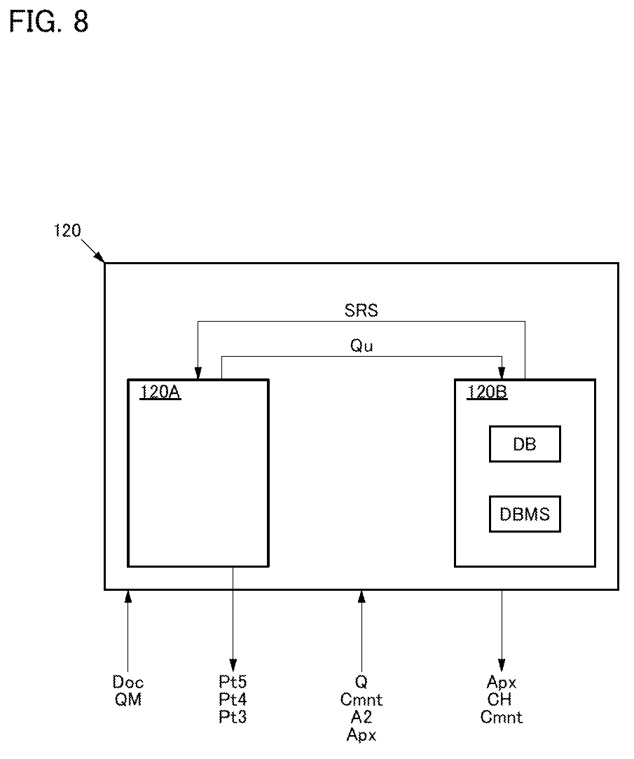

FIG. 8 illustrates a structure of the component that can be used in the information processing system of one embodiment of the present invention.

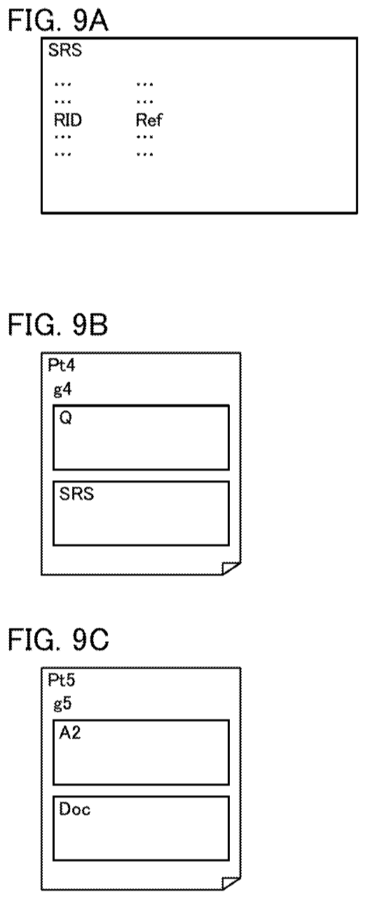

FIG. 9A illustrates a structure of a search result set created by the information processing system of one embodiment of the present invention, and FIGS. 9B and 9C each illustrate a structure of a prompt transmitted and received inside the information processing system of one embodiment of the present invention.

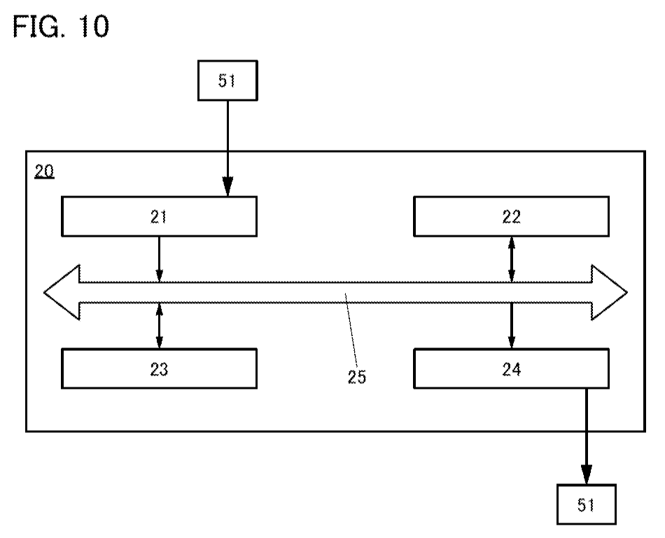

FIG. 10 is a block diagram illustrating a structure of an information processing device that can be used in the information processing system of one embodiment of the present invention.

### Structure example 1 of information processing system

The information processing system of one embodiment of the present invention includes a component 110, a component 130, and a component 120 (see FIG. 1).

An information processing device having a function of the component 110, an information processing device having a function of the component 130, and an information processing device having a function of the component 120 each include an arithmetic device and a communication device, for example. The communication devices in the information processing devices can be connected to one another via a network 51 to construct the information processing system of one embodiment of the present invention.

### Structure example 1 of component 110

The component 110 has a function of receiving a document Doc and transmitting it to the component 120.

A document describing how to work an invention can be used as the document Doc, for example. A document described such that a person with ordinary knowledge in the technical field of an invention for which a patent is sought can work the invention can also be used as the document Doc. A document described such that an invention can be specifically worked can also be used as the document Doc. In this specification, the document Doc includes a document describing an embodiment of an invention, and preferably includes a document specifically describing an embodiment of an invention.

For example, a user 99 of the information processing system inputs the document Doc to the component 110. For another example, the user 99 inputs a command for selecting and transmitting the document Doc stored in a variety of memory devices to the component 110. Specifically, the user 99 of the information processing system inputs the document Doc or the command to the component 110 with an input device such as a keyboard, a mouse, a facsimile machine, or an eye-gaze input device.

The component 110 has a function of receiving a comment Cmnt on the description of the document Doc and providing the comment Cmnt to the user 99 of the information processing system, for example. Specifically, the comment Cmnt is provided to the user 99 of the information processing system with an output device such as a display device, a speaker, a printer, a facsimile machine, or a variety of memory devices.

The component 110 includes a display device Dsp and an input device CID, for example (see FIG. 2A). The display device Dsp has a function of displaying the document Doc or the comment Cmnt. The display device Dsp also has a function of displaying a conversation history CH (see FIG. 2B).

### Structure example 1 of component 130

The component 130 has a function of receiving a prompt Pt1 and transmitting a question Q to the component 120, a function of receiving a prompt Pt2 and transmitting an answer A1 to the component 120, and a function of receiving a prompt Pt3 and transmitting the comment Cmnt to the component 120 (see FIG. 1). The component 130 also has a function of performing processing using a large language model LLM.

### Structure example 1 of large language model LLM

The large language model LLM has a function of generating the question Q in accordance with the prompt Pt1, a function of generating the answer A1 in accordance with the prompt Pt2, and a function of generating the comment Cmnt in accordance with the prompt Pt3.

A large language model such as GPT-3 (registered trademark), GPT-3.5, GPT-4 (registered trademark), LaMDA, Llama2, or Llama3 can be used as the large language model LLM, for example.

### Structure example 1 of component 120

The component 120 has a function of receiving the document Doc, the question Q, the answer A1, and the comment Cmnt and sharing them in the component 120.

The component 120 also has a function of transmitting the prompt Pt1, the prompt Pt2, and the prompt Pt3 to the component 130 and a function of transmitting the comment Cmnt to the component 110.

The component 120 includes a subcomponent 120A (see FIG. 3). In this specification, a structure having a single function or a plurality of functions is referred to as a component or a subcomponent for description convenience. When a component has a function of sharing information internally and includes a plurality of subcomponents, the plurality of subcomponents can utilize the same information.

### Structure example 1 of subcomponent 120A

The subcomponent 120A has a function of creating the prompt Pt1, the prompt Pt2, and the prompt Pt3.

### Structure example 1 of prompt Pt1

The prompt Pt1 includes an instruction g1, an object Obj, and the conversation history CH (see FIG. 4A). The instruction g1 includes a procedure for generating the question Q about the object Obj in consideration of the conversation history CH. Note that the object Obj is the document Doc or the answer A1, and the conversation history CH includes the question Q and the answer A1.

The document Doc can be divided into one or more logical paragraphs, each of which can be used as the object Obj, for example. When the prompt Pt1 is created for the first time, the conversation history CH is empty. When the prompt Pt1 is created for the second and subsequent times, the conversation history CH includes the question Q and the answer A1.

When the object Obj is the document Doc, for example, text in the next paragraph can be used as the prompt Pt1.

"Create a plurality of questions Q regarding when the object Obj is the document Doc."

For another example, when the object Obj is the answer A1, text in the next paragraph can be used as the prompt Pt1.

"Create a new question Q regarding the answer A1 in consideration of the conversation history CH."

### Structure example of prompt Pt2

The prompt Pt2 includes an instruction g2, the question Q, and the document Doc (see FIG. 5A). The instruction g2 includes a procedure for generating the answer A1 to the question Q from the description of the document Doc. Note that the answer A1 can include an impossibility to answer ITA.

For example, text in the next paragraph can be used as the prompt Pt2. Note that in the case where there is no description relevant to the question Q in the document Doc, the answer is the impossibility to answer ITA. Specifically, the answer A1 includes "no description".

"Create an answer to the question Q from the document Doc. In the case where there is no description relevant to the question Q in the document Doc, use "no description" as the answer."

### Structure example of prompt Pt3

The prompt Pt3 includes an instruction g3, the question Q, the answer A1, and the document Doc (see FIG. 5B). The instruction g3 includes a procedure for generating the comment Cmnt on the description of the document Doc relevant to the answer A1 to the question Q.

For example, text in the next paragraph can be used as the prompt Pt3.

"An answer to the question Q cannot be created from the document Doc. Provide what description should be added to the document Doc to create an answer to the question Q."

Accordingly, the question Q about the description of the document Doc can be created. The answer A1 to the question Q about the description of the document Doc can be created. The question Q and the answer A1 regarding the description of the document Doc can be repeatedly created. The description of the document Doc can be examined in detail. The comment Cmnt on the description of the document Doc relevant to the answer A1 to the question Q can be provided. Thus, a novel information processing system that is highly convenient, useful, or reliable can be provided.

### Structure example 2 of subcomponent 120A

The subcomponent 120A has a function of creating the prompt Pt1 when the document Doc or the answer A1 not including the impossibility to answer ITA is shared. The subcomponent 120A has a function of creating the prompt Pt2 when the question Q is shared. In this manner, a question and an answer can be repeatedly created.

The subcomponent 120A has a function of creating the prompt Pt3 when the answer A1 including the impossibility to answer ITA is shared. In other words, the subcomponent 120A creates the prompt Pt3 when the large language model LLM answers that an answer to the question Q cannot be created from the description of the document Doc.

Accordingly, the question Q can be generated when the document Doc or the answer A1 not including the impossibility to answer ITA is shared. The comment Cmnt can be generated when the answer A1 including the impossibility to answer ITA is shared. The comment Cmnt on the description of the document Doc relevant to the answer A1 to the question Q can be provided. The comment Cmnt can be used to promote the user of the information processing system to refine the document Doc, for example. Thus, a novel information processing system that is highly convenient, useful, or reliable can be provided.

### Structure example 2 of component 110

The component 110 has a function of receiving the conversation history CH and providing it to the user 99 of the information processing system, for example (see FIG. 1).

### Structure example 2 of component 120

The component 120 has a function of creating the conversation history CH and transmitting it to the component 110. Note that the conversation history CH includes the question Q and the answer A1 (see FIG. 2B).

Accordingly, the conversation history CH can be used to promote the user of the information processing system to refine the document Doc, for example. Thus, a novel information processing system that is highly convenient, useful, or reliable can be provided.

### Structure example 3 of component 110

The component 110 has a function of receiving a question material QM and transmitting it to the component 120 (see FIG. 1).

### Structure example of question material QM

The question material QM includes a point of view or an item to be noted at the time of generating a question. For example, the question material QM includes one or both of a concept notebook CN and frequently asked questions FAQ. Note that the frequently asked questions FAQ can be rephrased as a list of expected questions.

The document Doc is written on the basis of the concept notebook CN. In the case where a document describing how to work an invention, a document described such that a person with ordinary knowledge in the technical field of an invention for which a patent is sought can work the invention, or a document described such that an invention can be specifically worked is used as the document Doc, for example, a bullet list, a memorandum, a notebook, or the like describing how to work the invention can be used as the concept notebook CN.

As the frequently asked questions FAQ, for example, it is possible to use "is there any description of the operation and effect of an invention?", "is there any description of a reason why a structure example is preferable?", "is there any description of the definition of technical terms?", and "is there any description of the detailed conditions for experimental data?".

### Structure example 3 of component 120

The component 120 has a function of receiving the question material QM and sharing it in the component 120.

### Structure example 2 of prompt Pt1

The prompt Pt1 includes the instruction g1, the object Obj, the conversation history CH, and the question material QM (see FIG. 4B). The instruction g1 includes a procedure for generating the question Q about the object Obj in consideration of the conversation history CH with reference to the question material QM.

When the object Obj is the document Doc, for example, text in the next paragraph can be used as the prompt Pt1.

"Create a plurality of questions Q relevant to the question material QM from the document Doc."

For another example, when the object Obj is the answer A1, text in the next paragraph can be used as the prompt Pt1.

"Regarding the answer A1, create a new question Q relevant to the question material QM in consideration of the conversation history CH."

Accordingly, the question Q can be created with reference to the concept notebook CN. Whether the content of the concept notebook CN is described without omission in the document Doc can be examined in detail. The question Q can be created with reference to the frequently asked questions FAQ. Whether the document Doc is written to allow generation of answers to the frequently asked questions FAQ can be examined in detail. Thus, a novel information processing system that is highly convenient, useful, or reliable can be provided.

### Structure example 4 of component 110

The component 110 has a function of receiving a supplement Apx to the description of the document Doc and providing it to the user 99 of the information processing system, for example (see FIG. 6).

The component 110 includes the display device Dsp and the input device CID, for example (see FIG. 7A). The display device Dsp has a function of displaying the document Doc or the supplement Apx. The display device Dsp also has a function of displaying the conversation history CH (see FIG. 7B).

### Structure example 2 of component 130

The component 130 has a function of receiving a prompt Pt4 and a prompt Pt5 and transmitting the supplement Apx to the component 120 (see FIG. 6).

### Structure example 2 of large language model LLM

The large language model LLM has a function of generating an answer A2 to the question Q in accordance with the prompt Pt4 and a function of generating the supplement Apx to the answer A2 in accordance with the prompt Pt5.

### Structure example 4 of component 120

The component 120 has a function of receiving the supplement Apx and transmitting it to the component 110, a function of transmitting the prompt Pt4 and the prompt Pt5 to the component 130, and a function of sharing a search result set SRS in the component 120.

### Structure example 3 of subcomponent 120A

The subcomponent 120A has a function of creating a query Qu, the prompt Pt4, and the prompt Pt5.

### Structure example of query Qu

The query Qu includes a request to collect a reference Ref relevant to the question Q from a database DB and create the search result set SRS. Note that the reference Ref is included in the range of ordinary knowledge in the field of the document Doc.

The search result set SRS includes the reference Ref and literature information RID specifying the reference Ref, for example (see FIG. 9A).

### Structure example of prompt Pt4

The prompt Pt4 includes an instruction g4, the question Q, and the search result set SRS (see FIG. 9B). The instruction g4 includes a procedure for generating the answer A2 to the question Q from the reference Ref. Note that the answer A2 includes the literature information RID specifying the reference Ref.

For example, text in the next paragraph can be used as the prompt Pt4. Note that in the case where there is no description relevant to the question Q in the reference Ref, the answer is the impossibility to answer ITA. Specifically, the answer A2 includes "no description".

"Create an answer to the question Q from the reference Ref. In the case where there is no description relevant to the question Q in the reference Ref, use "no description" as the answer."

### Structure example of prompt Pt5

The prompt Pt5 includes an instruction g5, the answer A2, and the document Doc (see FIG. 9C). The instruction g5 includes a procedure for generating the supplement Apx to the description of the document Doc from the answer A2.

For example, text in the next paragraph can be used as the prompt Pt5.

"An answer to the question Q about the object Obj cannot be created from the document Doc. Create a draft supplementing the description of the document Doc on the basis of the answer A2 to create an answer."

### Structure example 5 of component 120

The component 120 includes a subcomponent 120B (see FIG. 8).

### Structure example of subcomponent 120B

The subcomponent 120B has a function of performing processing using the database DB and a management system DBMS.

Note that the database DB has a function of storing the reference Ref. For example, archives of official documents, archives of private documents, and archives of publicly known literature can be used as the database DB. Specifically, publications of patent applications, patent publications, books, literature, and the like can be included in a search target. The management system DBMS has a function of creating the search result set SRS from the database DB in response to the query Qu.

Accordingly, for example, the reference Ref can be collected in the range of ordinary knowledge in the field of the document Doc. The answer A2 to the question Q can be generated from the reference Ref. The literature information RID can be used to provide the basis for the answer A2 to the question Q. The supplement Apx can be used to provide the answer A2 to the question Q. Thus, a novel information processing system that is highly convenient, useful, or reliable can be provided.

### Structure example 4 of subcomponent 120A

The subcomponent 120A has a function of creating the query Qu when the answer A1 including the impossibility to answer ITA is shared. In other words, the subcomponent 120A creates the query Qu when the large language model LLM answers that an answer to the question Q cannot be created from the description of the document Doc.

The subcomponent 120A has a function of creating the prompt Pt4 when the search result set SRS is shared.

The subcomponent 120A has a function of creating the prompt Pt5 when the answer A2 not including the impossibility to answer ITA is shared. In other words, the subcomponent 120A creates the prompt Pt5 when the large language model LLM creates an answer to the question Q from the description of the reference Ref.

The subcomponent 120A has a function of creating the prompt Pt3 when the answer A2 including the impossibility to answer ITA is shared. In other words, the subcomponent 120A creates the prompt Pt3 when the large language model LLM answers that an answer to the question Q cannot be created not only from the description of the document Doc but also from the search result set SRS.

Accordingly, when the answer A1 including the impossibility to answer ITA is shared, the query Qu can be created and the search result set SRS including the reference Ref can be created from the database DB. When the search result set SRS is shared, the answer A2 to the question Q can be generated from the reference Ref. When the answer A2 does not include the impossibility to answer ITA, the supplement Apx to the description of the document Doc relevant to the answer A2 to the question Q can be generated from the answer A2. The supplement Apx can be used to promote the user of the information processing system to refine the document Doc, for example. When the answer A2 includes the impossibility to answer ITA, the comment Cmnt on the description of the document Doc relevant to the question Q can be provided. The comment Cmnt can be used to promote the user of the information processing system to refine the document Doc, for example. Thus, a novel information processing system that is highly convenient, useful, or reliable can be provided.

### Structure example 2 of information processing system

Another information processing system described in this embodiment includes the component 110, the component 120, and the component 130 (see FIG. 1).

The information processing system of one embodiment of the present invention can be composed of an information processing device having a function of the component 110, an information processing device having a function of the component 120, and an information processing device having a function of the component 130, for example. Note that the number of information processing devices constituting the information processing system of one embodiment of the present invention is one or more. For example, a plurality of information processing devices can be connected to one another using the network 51 to construct the information processing system of one embodiment of the present invention.

When the information processing system of one embodiment of the present invention is composed of the plurality of information processing devices, loads relating to information processing can be dispersed.

### Structure example 1 of information processing device

The information processing device with a structure example 1 described in this embodiment can be used as the component 110. The information processing device with the structure example 1 can be referred to as a client computer or the like. For example, a desktop computer or a mobile computer can be used as the component 110.

The information processing device with the structure example 1 can receive data input by the user of the information processing system of one embodiment of the present invention. The information processing device with the structure example 1 can provide data output from the information processing system of one embodiment of the present invention to the user.

For example, dedicated application software or a web browser operates in the component 110. Via either of them, the user of the information processing system of one embodiment of the present invention can access the information processing system. Thus, the user can receive service using the information processing system of one embodiment of the present invention.

### Structure Example 2 of information processing device

The information processing device with a structure example 2 described in this embodiment can be used as the component 120. For example, a workstation, a server computer, or a supercomputer can be used as the component 120.

The information processing device with the structure example 2 preferably has a function of a parallel computer. When the information processing device with this structure is used as a parallel computer, large-scale computation necessary for artificial intelligence (AI) learning and inference can be performed, for example.

Furthermore, the information processing device with the structure example 2 can perform processing using a natural language model with the use of AI.

For example, it is preferable that the information processing device be capable of performing processing using a natural language model such as GPT-3 (registered trademark), GPT-3.5, GPT-4 (registered trademark), LaMDA, Llama2, or Llama3.

### Structure example 3 of information processing device

The information processing device with a structure example 3 described in this embodiment can be used as the component 130, for example. Note that the component 130 has a larger scale and higher computational capability than the component 120. For example, a large computer such as a server computer or a supercomputer can be used as the component 130.

The information processing device with the structure example 3 preferably has a function of a parallel computer. When the information processing device with this structure is used as a parallel computer, large-scale computation necessary for AI learning and inference can be performed, for example.

Furthermore, the information processing device with the structure example 3 can perform processing using a natural language model with the use of AI. In particular, it is possible to perform processing using a general-purpose language model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable that processing using GPT-4 (registered trademark) be available. For example, processing using a language model that is larger in scale than a conventional natural language model can achieve more natural text generation, interaction, or the like.

Note that a service provider using the information processing system of one embodiment of the present invention does not necessarily have its own information processing device with the structure example 3. For example, a service provider can utilize part of the service that another company or the like provides using the information processing device with the structure example 3.

### Structure example of network 51

The network 51 that can be used for the information processing system of one embodiment of the present invention can connect the plurality of information processing devices to one another. Thus, the plurality of information processing devices connected to one another can transmit and receive data to and from one another. Furthermore, loads of the information processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the information processing system of one embodiment of the present invention can provide service using an information processing method of one embodiment of the present invention via the network 51, for example.

In the case where the information processing system of one embodiment of the present invention is constructed in a local network, the possibility of leakage of confidential information can be lower than that in the case of using the Internet, for example.

### Structure example 4 of information processing device

An information processing device 20 that can be used for the information processing system of one embodiment of the present invention includes, for example, an input unit 21, a storage unit 22, a processing unit 23, an output unit 24, and a transmission path 25 (see FIG. 10).

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed in the processing unit 23 is sometimes executed by a different information processing device depending on the processing.

### Input unit 21

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### Storage unit 22

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The information processing device can include a database in addition to the storage unit 22. The information processing device can have a function of extracting data from a database outside the storage unit 22, outside the information processing device, or outside the information processing system. Alternatively, the information processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for "nonvolatile oxide semiconductor random access memory (RAM)". The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for "dynamic oxide semiconductor RAM" and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or an indium gallium zinc oxide (an In–Ga–Zn oxide, also referred to as "IGZO") can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high binding energy with oxygen. The element M is, for example, an element that has higher binding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., a zinc tin oxide or a gallium tin oxide).

### Processing unit 23

The processing unit 23 has a function of performing processing such as arithmetic operation, analysis, and inference with use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as "learning" in some cases.

In this specification and the like, drawing a new conclusion from a neural network formed with the connection strength obtained by learning is referred to as "inference" in some cases.

### Output unit 24

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as the input unit 21 and the output unit 24.

### Transmission path 25

The transmission path 25 has a function of transmitting data. Data transmission and reception between the input unit 21, the storage unit 22, the processing unit 23, and the output unit 24 can be performed via the transmission path 25. Specifically, an external bus, a LAN, or the Internet can be used for the transmission path 25.

Note that this embodiment can be combined with the other embodiment in this specification as appropriate.

### Embodiment 2

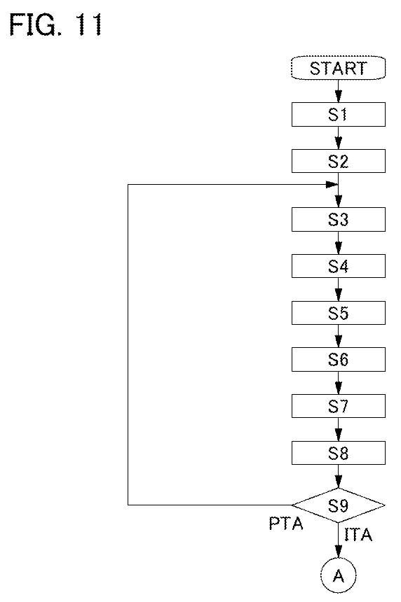

In this embodiment, an information processing method of one embodiment of the present invention will be described with reference to FIG. 11 to FIG. 14.

FIG. 11 is a flowchart showing the information processing method of one embodiment of the present invention.

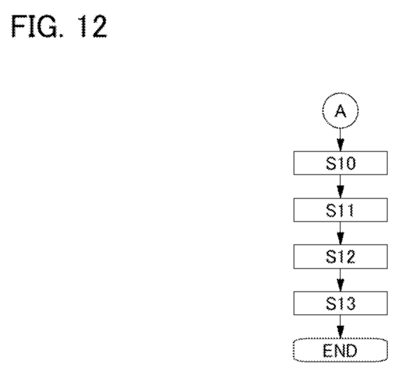

FIG. 12 is a flowchart showing the information processing method of one embodiment of the present invention.

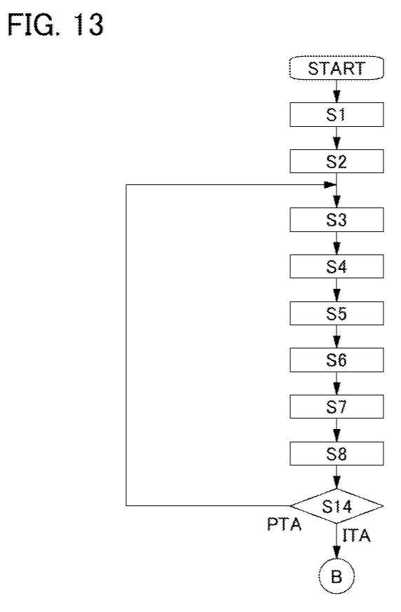

FIG. 13 is a flowchart showing the information processing method of one embodiment of the present invention.

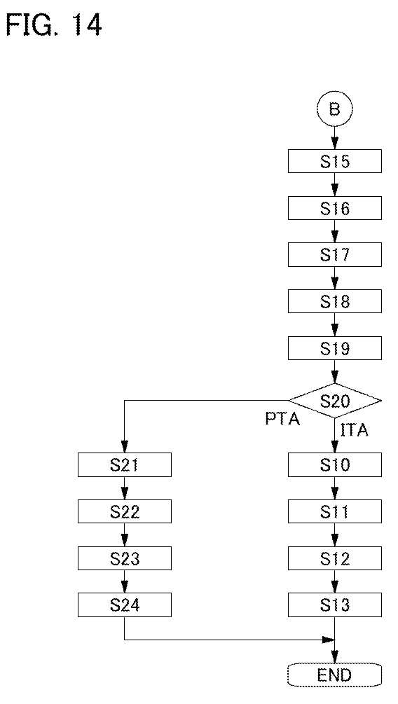

FIG. 14 is a flowchart showing the information processing method of one embodiment of the present invention.

### Example 1 of information processing method

The information processing method of one embodiment of the present invention includes Steps S1 to S13 (see FIGS. 11 and 12).

### Step S1

In Step S1, the component 110 receives the document Doc and transmits it to the component 120 (see FIG. 11).

For example, the user 99 of the information processing system inputs the document Doc to the component 110. For another example, the user 99 inputs a command for selecting and transmitting the document Doc stored in a memory device to the component 110.

### Step S2

In Step S2, the component 120 receives the document Doc and shares it in the component 120. The component 120 includes the subcomponent 120A.

### Step S3

In Step S3, the subcomponent 120A creates the prompt Pt1 and transmits it to the component 130.

The prompt Pt1 includes the instruction g1, the object Obj, and the conversation history CH, and the instruction g1 includes a procedure for generating the question Q about the object Obj in consideration of the conversation history CH. When the prompt Pt1 is created for the first time, the object Obj is the document Doc. When the prompt Pt1 is created for the second and subsequent times, the object Obj is the answer A1. When the prompt Pt1 is created for the first time, the conversation history CH is empty. When the prompt Pt1 is created for the second and subsequent times, the conversation history CH includes the question Q and the answer A1.

### Step S4

In Step S4, the component 130 receives the prompt Pt1. The component 130 generates the question Q with the use of the large language model LLM and transmits the question Q to the component 120.

### Step S5

In Step S5, the component 120 receives the question Q and shares it in the component 120.

### Step S6

In Step S6, the subcomponent 120A creates the prompt Pt2 and transmits it to the component 130.

The prompt Pt2 includes the instruction g2, the question Q, and the document Doc, and the instruction g2 includes a procedure for generating the answer A1 to the question Q from the description of the document Doc. Note that the answer A1 can include the impossibility to answer ITA.

### Step S7

In Step S7, the component 130 receives the prompt Pt2. The component 130 generates the answer A1 with the use of the large language model LLM and transmits the answer A1 to the component 120.

### Step S8

In Step S8, the component 120 receives the answer A1 and shares it in the component 120.

### Step S9

In Step S9, when the component 120 shares the answer A1 not including the impossibility to answer ITA (corresponding to PTA in FIG. 11), the process proceeds to Step S3. When the component 120 shares the answer A1 including the impossibility to answer ITA (corresponding to ITA in FIG. 11), the process proceeds to Step S10 (see FIG. 12).

### Step S10

In Step S10, the subcomponent 120A creates the prompt Pt3 and transmits it to the component 130.

The prompt Pt3 includes the instruction g3, the question Q, and the document Doc, and the instruction g3 includes a procedure for generating the comment Cmnt on the description of the document Doc relevant to the answer A1 to the question Q.

### Step S11

In Step S11, the component 130 receives the prompt Pt3, generates the comment Cmnt with the use of the large language model LLM, and transmits the comment Cmnt to the component 120.

### Step S12

In Step S12, the component 120 receives the comment Cmnt and transmits it to the component 110.

### Step S13

In Step S13, the component 110 receives the comment Cmnt and provides it to the user 99 of the information processing system, for example.

Accordingly, the question Q about the description of the document Doc can be created. The answer A1 to the question Q about the description of the document Doc can be created. The question Q and the answer A1 regarding the description of the document Doc can be repeatedly created. The description of the document Doc can be examined in detail. The comment Cmnt on the description of the document Doc relevant to the answer A1 to the question Q can be provided. The question Q can be generated when the document Doc or the answer A1 not including the impossibility to answer ITA is shared. The comment Cmnt can be generated when the answer A1 including the impossibility to answer ITA is shared. The comment Cmnt on the description of the document Doc relevant to the answer A1 to the question Q can be provided. The comment Cmnt can be used to promote the user of the information processing system to refine the document Doc, for example. Thus, a novel information processing method that is highly convenient, useful, or reliable can be provided.

### Example 2 of information processing method

The information processing method of another embodiment of the present invention includes Steps S14 to S24 instead of Step S9 (see FIG. 13 and FIG. 14).

### Step S14

In Step S14, when the component 120 shares the answer A1 not including the impossibility to answer ITA (corresponding to PTA in FIG. 13), the process proceeds to Step S3, and when the component 120 shares the answer A1 including the impossibility to answer ITA (corresponding to ITA in FIG. 13), the process proceeds to Step S15 (see FIG. 13).

### Step S15

In Step S15, the subcomponent 120A creates the query Qu and shares it in the component 120 (see FIG. 14).

The query Qu includes a request to collect the reference Ref relevant to the question Q from the database DB and create the search result set SRS. Note that the reference Ref is included in the range of ordinary knowledge in the field of the document Doc.

The component 120 includes the subcomponent 120B. The subcomponent 120B has a function of performing processing using the database DB and the management system DBMS. The database DB has a function of storing the reference Ref, and the management system DBMS has a function of creating the search result set SRS from the database DB in response to the query Qu.

### Step S16

In Step S16, the subcomponent 120B creates the search result set SRS and shares it in the component 120.

### Step S17

In Step S17, the subcomponent 120A creates the prompt Pt4 and transmits it to the component 130.

The prompt Pt4 includes the instruction g4, the question Q, and the search result set SRS, and the instruction g4 includes a procedure for generating the answer A2 to the question Q from the reference Ref. Note that the answer A2 includes the literature information RID specifying the reference Ref. The answer A2 can include the impossibility to answer ITA.

### Step S18

In Step S18, the component 130 receives the prompt Pt4, generates the answer A2 with the use of the large language model LLM, and transmits the answer A2 to the component 120.

### Step S19

In Step S19, the component 120 receives the answer A2 and shares it in the component 120.

### Step S20

In Step S20, when the component 120 shares the answer A2 including the impossibility to answer ITA (corresponding to ITA in FIG. 14), the process proceeds to Step S10. When the component 120 shares the answer A2 not including the impossibility to answer ITA (corresponding to PTA in FIG. 14), the process proceeds to Step S21.

### Step S21

In Step S21, the subcomponent 120A creates the prompt Pt5 and transmits it to the component 130.

The prompt Pt5 includes the instruction g5, the answer A2, and the document Doc, and the instruction g5 includes a procedure for generating the supplement Apx to the description of the document Doc from the answer A2.

### Step S22

In Step S22, the component 130 receives the prompt Pt5. The component 130 generates the supplement Apx with the use of the large language model LLM and transmits the supplement Apx to the component 120.

### Step S23

In Step S23, the component 120 receives the supplement Apx and transmits it to the component 110.

### Step S24

In Step S24, the component 110 receives the supplement Apx and provides it to the user 99 of the information processing system, for example.

Accordingly, for example, the reference Ref can be collected in the range of ordinary knowledge in the field of the document Doc. The answer A2 to the question Q can be generated from the reference Ref. The literature information RID can be used to provide the basis for the answer A2 to the question Q. The supplement Apx can be used to provide the answer A2 to the question Q. When the answer A1 including the impossibility to answer ITA is shared, the query Qu can be created and the search result set SRS including the reference Ref can be created from the database DB. When the search result set SRS is shared, the answer A2 to the question Q can be generated from the reference Ref. When the answer A2 does not include the impossibility to answer ITA, the supplement Apx to the description of the document Doc relevant to the question Q can be generated from the answer A2. The supplement Apx can be used to promote the user of the information processing system to refine the document Doc, for example. When the answer A2 includes the impossibility to answer ITA, the comment Cmnt on the description of the document Doc relevant to the question Q can be provided. The comment Cmnt can be used to promote the user of the information processing system to refine the document Doc, for example. Thus, a novel information processing method that is highly convenient, useful, or reliable can be provided.

Note that this embodiment can be combined with the other embodiment in this specification as appropriate.

This application is based on Japanese Patent Application Serial No. 2025-062072 filed with Japan Patent Office on Apr. 3, 2025, the entire contents of which are hereby incorporated by reference.

What is claimed is:

1. An information processing system,
wherein the information processing system is configured to receive a document,
wherein the information processing system is configured to provide a comment on a description in the document in accordance with a first question,
wherein a first answer to the first question comprises an impossibility to answer, and
wherein the first question relates to the document or a second answer given in response to a second question and not comprising the impossibility to answer.

2. An information processing system,
wherein the information processing system is configured to receive a document and to provide a comment,
wherein the information processing system is configured to transmit a first prompt to a large language model, to receive a question in response to the first prompt, to transmit a second prompt to the large language model, to receive an answer to the question in response to the second prompt, to transmit a third prompt to the large language model, and to receive a comment in response to the third prompt,
wherein the first prompt comprises a first instruction, an object, and a conversation history,
wherein the first instruction comprises a procedure for generating the question about the object in consideration of the conversation history,
wherein the object is the document or an answer to a previous question,
wherein the conversation history comprises the previous question and the answer to the previous question,
wherein the second prompt comprises a second instruction, the question, and the document,
wherein the second instruction comprises a procedure for generating the answer to the question from a description of the document,
wherein a content of the answer comprises an opinion including an impossibility to answer the question or an opinion including a proper answer to the question,
wherein the third prompt comprises a third instruction, the question, the answer, and the document, and
wherein the third instruction comprises a procedure for generating the comment on the description in the document relevant to the answer to the question.

3. An information processing system comprising:
a first component configured to receive a document, to transmit the document to a third component, and to receive and provide a comment;
a second component configured to receive a first prompt, to generate and transmit a question to the third component in accordance with the first prompt, to receive a second prompt, to generate and transmit a first answer to the third component in accordance with the second prompt, to receive a third prompt, to generate and transmit the comment to the third component in accordance with the third prompt, and to perform processing using a large language model; and
the third component configured to receive the document, the question, the first answer, and the comment, to create and transmit the first prompt, the second prompt, and the third prompt to the second component, and to transmit the comment to the first component,
wherein the first prompt comprises a first instruction, an object, and a conversation history,
wherein the first instruction comprises a procedure for generating the question about the object in consideration of the conversation history,
wherein the object is the document or a second answer to a previous question,
wherein the conversation history comprises the previous question and the second answer,
wherein the second prompt comprises a second instruction, the question, and the document,
wherein the second instruction comprises a procedure for generating the first answer to the question from a description in the document,
wherein a content of the first answer comprises an opinion including an impossibility to answer the question or an opinion including a proper answer to the question,
wherein the third prompt comprises a third instruction, the question, the first answer, and the document, and
wherein the third instruction comprises a procedure for generating the comment on the description in the document relevant to the first answer to the question.

4. The information processing system according to claim 3,
wherein a first subcomponent included in the third component is configured to:
create the first prompt when the document or the first answer not comprising the impossibility to answer is shared;
create the second prompt when the question is shared; and
create the third prompt when the first answer comprising the impossibility to answer is shared.

5. The information processing system according to claim 3,
wherein the first component is configured to receive and provide a record,
wherein the third component is configured to create and transmit the record to the first component, and
wherein the record comprises the question and the first answer.

6. The information processing system according to claim 3,
wherein the first component is configured to receive and transmit a question material comprising one or both of a concept notebook and a frequently asked question to the third component,
wherein the document is based on the concept notebook,
wherein the third component is configured to receive the question material and share the question material in the third component,
wherein the first prompt comprises the first instruction, the object, the conversation history, and the question material, and
wherein the first instruction comprises a procedure for generating the question about the object in consideration of the conversation history with reference to the question material.

7. The information processing system according to claim 4,
wherein the first component is configured to receive and provide a supplement,
wherein the second component is configured to receive a fourth prompt and a fifth prompt and transmit the supplement to the third component,
wherein the large language model is configured to generate a third answer to the question in accordance with the fourth prompt and to generate the supplement relevant to the third answer in accordance with the fifth prompt,
wherein the third component is configured to receive the supplement and transmit the supplement to the first component, to transmit the fourth prompt and the fifth prompt to the second component, and to share a search result set in the third component,
wherein the third component comprises a second subcomponent,
wherein the first subcomponent is configured to create a query, the fourth prompt, and the fifth prompt,
wherein the query comprises a request to collect a reference relevant to the question from a database and create the search result set,
wherein the reference is within a range of ordinary knowledge in a field of the document,
wherein the fourth prompt comprises a fourth instruction, the question, and the search result set,
wherein the fourth instruction comprises a procedure for generating the third answer to the question from the reference,
wherein the third answer comprises literature information specifying the reference,
wherein the fifth prompt comprises a fifth instruction, the third answer, and the document,
wherein the fifth instruction comprises a procedure for generating the supplement to the description of the document from the third answer,
wherein the third answer is capable of comprising the impossibility to answer,
wherein the second subcomponent is configured to perform processing using the database and a management system,
wherein the database is configured to store the reference, and
wherein the management system is configured to create the search result set from the database in response to the query.

8. The information processing system according to claim 7,
wherein the first subcomponent is configured to:
create the query when the first answer comprising the impossibility to answer is shared;
create the fourth prompt when the search result set is shared;
create the fifth prompt when the third answer not comprising the impossibility to answer is shared; and
create the third prompt when the third answer comprising the impossibility to answer is shared.

9. An information processing method comprising:
a first step, a second step, a third step, a fourth step, a fifth step, a sixth step, a seventh step, an eighth step, and a ninth step,
wherein a first component receives a document and transmits the document to a second component comprising a first subcomponent in the first step,
wherein the first subcomponent creates a first prompt comprising a first instruction, an object, and a conversation history and transmits the first prompt to a third component in the second step,
wherein the first instruction comprises a procedure for generating a question about the object in consideration of the conversation history,
wherein the object is the document when the first prompt is created for a first time, and is a first answer when the first prompt is created for a second time,
wherein the conversation history comprises a question generated in accordance with the first prompt when the first prompt is created for the first time and the first answer when the first prompt is created for the second time,
wherein the third component receives the first prompt, generates the question with use of a large language model, and transmits the question to the second component in the third step,
wherein the first subcomponent creates a second prompt comprising a second instruction, the question, and the document and transmits the second prompt to the third component in the fourth step,
wherein the second instruction comprises a procedure for generating the first answer to the question from a description in the document,
wherein a content of the first answer comprises an opinion including an impossibility to answer the question or an opinion including a proper answer to the question,
wherein the third component receives the second prompt, generates the first answer with use of the large language model, and transmits the first answer to the second component in the fifth step,
wherein, when the second component shares the first answer comprising the opinion including the proper answer to the question in the sixth step, a process proceeds to the second step,
wherein, when the second component shares the first answer comprising the opinion including the impossibility to answer in the sixth step, the process proceeds to the seventh step,
wherein the first subcomponent creates a third prompt and transmits the third prompt to the third component in the seventh step,
wherein the third prompt comprises a third instruction, the question, and the document,
wherein the third instruction comprises a procedure for generating a comment on the description in the document relevant to the first answer to the question,
wherein the third component receives the third prompt, generates the comment with use of the large language model, and transmits the comment to the second component in the eighth step, and
wherein the second component receives the comment and transmits the comment to the first component in the ninth step.

10. The information processing method according to claim 9, further comprising:
a tenth step, an eleventh step, a twelfth step, a thirteenth step, a fourteenth step, a fifteenth step, a sixteenth step, a seventeenth step, an eighteenth step, and a nineteenth step instead of the sixth step,
wherein, when the second component shares the first answer comprising the opinion including the proper answer to the question in the tenth step, the process proceeds to the second step,
wherein, when the second component shares the first answer comprising the opinion including the impossibility to answer in the tenth step, the process proceeds to the eleventh step,
wherein the first subcomponent creates a query comprising a request to collect a reference relevant to the question from a database and create a search result set and shares the query in the second component in the twelfth step,
wherein the reference is within a range of ordinary knowledge in a field of the document,
wherein the second component comprises a second subcomponent configured to perform processing using the database configured to store the reference and a management system configured to create the search result set from the database in response to the query,
wherein the second subcomponent creates the search result set and shares the search result set in the second component in the thirteenth step,
wherein the first subcomponent creates a fourth prompt comprising a fourth instruction, the question, and the search result set and transmits the fourth prompt to the third component in the fourteenth step,
wherein the fourth instruction comprises a procedure for generating a second answer comprising literature information specifying the reference to the question from the reference,
wherein a content of the second answer comprises an opinion including the impossibility to answer the question or an opinion including a proper answer to the question,
wherein the third component receives the fourth prompt, generates the second answer with use of the large language model, and transmits the second answer to the second component in the fifteenth step,
wherein, when the second component shares the second answer comprising the opinion including the impossibility to answer in the sixteenth step, the process proceeds to the seventh step,
wherein, when the second component shares the second answer comprising the opinion including the proper answer to the question in the sixteenth step, the process proceeds to the seventeenth step,
wherein the first subcomponent creates a fifth prompt comprising a fifth instruction, the second answer, and the document and transmits the fifth prompt to the third component in the seventeenth step,
wherein the fifth instruction comprises a procedure for generating a supplement to the description in the document from the second answer,
wherein the third component receives the fifth prompt, generates the supplement with use of the large language model, and transmits the supplement to the second component in the eighteenth step, and
wherein the second component receives the supplement and transmits the supplement to the first component in the nineteenth step.
